(19) United States
(12) Patent Application Publication
(10) Pub. No.: US 2019/0295094 A1
(43) Pub. Date: Sep. 26, 2019

(54) SYSTEM AND METHOD FOR ENABLING RECEIPT OF ELECTRONIC PAYMENTS

(71) Applicant: Mastercard International Incorporated, Purchase, NY (US)

(72) Inventors: Ankur ARORA, New Delhi (IN); Chandan Garg, Gurgoan (IN); Aditya Koduri, Gurgoan (IN)

(21) Appl. No.: 16/277,488

(22) Filed: Feb. 15, 2019

(30) Foreign Application Priority Data
Mar. 26, 2018 (IN) 201811011047

(51) Int. Cl. G06Q 20/40; G06Q 20/10; G06Q 20/32

(52) U.S. Cl. CPC G06Q 20/40145; G06Q 20/20; G06Q 20/3223; G06Q 20/10

(57) ABSTRACT

The present invention is directed to systems and methods for enabling electronic payments to merchants who do not have access to a terminal device or point of sale device for receiving electronic payments. The invention comprises performing an electronic payment transaction through the steps of (i) receiving user input identifying a transaction amount, (ii) acquiring through a first biometric feature sensor, a first set of biometric information defining a biometric feature of a payment transferee, (iii) generating a first biometric template based on the acquired first set of biometric information, and (iv) transferring the transaction amount from a first electronic payment account associated with a payment transferor to a second electronic payment account associated with the payment transferee, wherein the second electronic payment account is identified based on the first biometric template.

### CROSS-REFERENCE TO RELATED APPLICATIONS

This application claims priority to Indian Patent Application No. 201811011047 filed on Mar. 26, 2018, which is hereby incorporated by reference in its entirety.

### FIELD OF THE INVENTION

The present invention relates to the field of electronic transactions, and more specifically to systems and methods for enabling electronic payments to merchants who do not have access to a terminal device or point of sale device for receiving electronic payments.

### BACKGROUND OF THE INVENTION

Electronic payment transactions using payment cards or electronic payment accounts are increasingly common—with the number of electronic payment transactions and ubiquity of electronic transaction mechanisms and services growing steadily.

For several reasons, a disproportionately large segment of the population continues to rely on cash transactions and remains excluded from electronic payment transaction facilities—including lack of access to banks and electronic payment services, lack of sufficient bankable funds to open or maintain an account, lack of familiarity with banking procedures etc.

The lack of access to electronic payment transaction infrastructure has a damping effect on commerce, particularly in cases where a merchant or intended recipient of payment lacks such access—as consumers who wish to execute a purchase transaction or payment transaction electronically are unable to do so. Additionally, while a merchant or intended recipient may in principle be willing to receive payment electronically—the costs, know-how and efforts involved in (i) setting up a mechanism for receiving electronic payments, (ii) being able to convert such payments into cash, and (iii) acquiring the necessary infrastructure for receiving electronic payments (e.g. the costs of acquiring a point-of-sale terminal device), may serve as a barrier to entry.

There is accordingly a need for systems and methods that facilitate financial inclusion by enabling merchants or intended recipients of payments to accept payments electronically, without having a pre-existing set up for processing or receiving electronic payments.

### SUMMARY

The present invention is directed to systems and methods for enabling electronic payments to merchants who do not have access to a terminal device or point of sale device for receiving electronic payments.

In one embodiment, the invention comprises a method for performing an electronic payment transaction. The method comprises the steps of (i) receiving user input identifying a transaction amount, (ii) acquiring through a first biometric feature sensor, a first set of biometric information defining a biometric feature of a payment transferee, (iii) generating a first biometric template based on the acquired first set of biometric information, and (iv) transferring the transaction amount from a first electronic payment account associated with a payment transferor to a second electronic payment account associated with the payment transferee, wherein the second electronic payment account is identified based on the first biometric template.

In an embodiment of said method, identifying the second electronic payment account comprises (i) comparing the first biometric template against a plurality of pre-stored biometric templates, wherein each pre-stored biometric template is associated with a corresponding pre-existing electronic payment account, and (ii) responding to a determined match between the first biometric template and a second biometric template from among the plurality of pre-stored biometric templates, by identifying as the second electronic payment account, a pre-existing electronic payment account associated with said second biometric template.

Identifying the second electronic payment account may comprise responding to a determination that the first biometric template does not match any of the plurality of pre-stored biometric templates with the further steps of (i) generating a new electronic payment account and associating said new electronic payment account with the first biometric template, and (ii) identifying the generated new electronic payment account as the second electronic payment account.

The first electronic payment account may be identified based on electronic payment account information from a user account associated with the payment transferor. Additionally, one or more of the user input and the biometric information may be acquired through the payment transferor's mobile communication device.

In an embodiment of the method, the biometric feature comprises any of a fingerprint, facial feature, palm print, eye image, iris image, retina image or voice sample.

The method may additionally include the steps of (i) generating a transaction identifier uniquely associated with the transaction under execution, and (ii) communicating said transaction identifier to the second electronic payment account.

In a further embodiment, the method comprises the steps of (i) receiving at a terminal device having cash disbursement capabilities, input identifying the second electronic payment account, (ii) receiving input selecting one or more payments received into the second electronic payment account, and (iii) disbursing cash equivalent to the selected one or more payments from the terminal device.

The received input identifying the second electronic payment account may comprise a second set of biometric information defining a biometric feature of the payment transferee.

In one embodiment of the method, the second set of biometric information is acquired through a second biometric feature sensor associated with the terminal device having cash disbursement facilities.

The invention additionally provides a system for performing an electronic payment transaction. The system comprises a processor implemented payment server configured for (i) receiving user input identifying a transaction amount, (ii) receiving a first set of biometric information defining a biometric feature of a payment transferee, wherein said first set of biometric information is acquired through a first biometric feature sensor, (iii) acquiring a first biometric template, wherein said first biometric template is generated based on the acquired first set of biometric information, and (iv) transferring the transaction amount from a first electronic payment account associated with a payment transferor to a second electronic payment account associated with the payment transferee, wherein the second electronic payment account is identified based on the first biometric template.

In a system embodiment, identifying the second electronic payment account comprises (i) comparing the first biometric template against a plurality of pre-stored biometric templates, wherein each pre-stored biometric template is associated with a corresponding pre-existing electronic payment account, and (ii) responding to a determined match between the first biometric template and a second biometric template from among the plurality of pre-stored biometric templates, by identifying as the second electronic payment account, a pre-existing electronic payment account associated with said second biometric template.

In a particular system embodiment, identifying the second electronic payment account comprises responding to a determination that the first biometric template does not match any of the plurality of pre-stored biometric templates with the further steps of (i) generating a new electronic payment account and associating said new electronic payment account with the first biometric template, and (ii) identifying the generated new electronic payment account as the second electronic payment account.

In one embodiment of the system the first electronic payment account is identified based on electronic payment account information from a user account associated with the payment transferor. Further, one or more of the user input and the biometric information may be acquired at the payment server through a mobile communication device. In a specific system embodiment, the biometric feature comprises any of a fingerprint, facial feature, palm print, eye image, iris image, retina image or voice sample.

The payment server of the system may be configured to (i) generate a transaction identifier uniquely associated with the transaction under execution, and (ii) communicate said transaction identifier to the second electronic payment account.

The payment server may also be configured to (i) receive through a terminal device having cash disbursement capabilities, input identifying the second electronic payment account, (ii) receive through said terminal device, input selecting one or more payments received into the second electronic payment account, and (iii) implement disbursement of cash equivalent to the selected one or more payments, at the terminal device.

The received input identifying the second electronic payment account may in a specific system embodiment comprise a second set of biometric information defining a biometric feature of the payment transferee. In a further embodiment of the system, the second set of biometric information may be acquired through a second biometric feature sensor associated with the terminal device having cash disbursement facilities.

The invention additionally provides a computer program product for performing an electronic payment transaction. The computer program product comprises a non-transitory computer usable medium having computer readable program code embodied therein, the computer readable program code comprising instructions for (i) receiving user input identifying a transaction amount, (ii) acquiring through a first biometric feature sensor, a first set of biometric information defining a biometric feature of a payment transferee, (iii) generating a first biometric template based on the acquired first set of biometric information, and (iv) transferring the transaction amount from a first electronic payment account associated with a payment transferor to a second electronic payment account associated with the payment transferee, wherein the second electronic payment account is identified based on the first biometric template.

### BRIEF DESCRIPTION OF THE ACCOMPANYING DRAWINGS

FIG. 1 illustrates a conventional system for authenticating and implementing electronic payments through an electronic payment network.

FIGS. 2 to 5 illustrate flowcharts corresponding to methods in accordance with the present invention.

FIG. 6 illustrates a system for enabling a merchant or intended recipient of payment to receive electronic payments in accordance with the present invention.

FIG. 7 illustrates a payment server configured in accordance with the teachings of the present invention.

FIG. 8 illustrates an exemplary computer system according to which various embodiments of the present invention may be implemented.

### DETAILED DESCRIPTION

The invention facilitates financial inclusion of individuals and enterprises which lack access to electronic payment infrastructure, and enables such individuals and enterprises to receive electronic payments despite lacking ownership or possession of terminal devices (for example Point-of-Sale terminals or mobile communication devices capable of effecting electronic transactions) for effecting electronic payment transactions, or having pre-existing payment infrastructure for receiving electronic payments.

For the purposes of the present invention, the following terms shall be understood to have the corresponding meanings provided below:

“Acquirer” shall mean a business (e.g., a financial institution or a merchant bank) that contracts with a merchant to coordinate with the issuer network of a customers' payment card or payment account.

“Acquirer network” shall refer to a communication network, including hardware, software and other equipment used by an acquirer to transmit and process card based transactions and information related to merchants, customers, payment cards and transactions.

“Biometric template” shall mean a digital reference or digital record of distinct biometric features or characteristics that have been extracted from a biometric sample.

“Cardholder” or “Customer” shall mean an authorized payment card user who is making a purchase or effecting an electronic transaction with a payment card or payment account.

“Payment network” shall refer to an intermediary network (for example, Mastercard® or Visa®) between the merchant's acquirer and the customer's issuer. The payment network primarily coordinates electronic payment transactions between acquirers and issuers, and additionally coordinates clearing and settlement services to transfer payments from issuers to merchants.

“Issuer” shall mean a financial institution or entity that issues payment cards or payment accounts and maintains a contract with a customer or card holder for repayment or settlement of transactions made on the payment card or through the payment account.

“Issuer network” shall refer to a communication network, including hardware, software and other equipment used by an issuer to transmit and process electronic payment transactions and information related to customers, payment cards, electronic payment accounts and transactions.

“Merchant” shall mean an individual offering goods or services in return for financial consideration or payment.

“Payment account” shall mean any account that may be used for the purposes of effecting an electronic payment or electronic transaction, and shall include any electronic transaction account, payment card account, bank account or electronic wallet account.

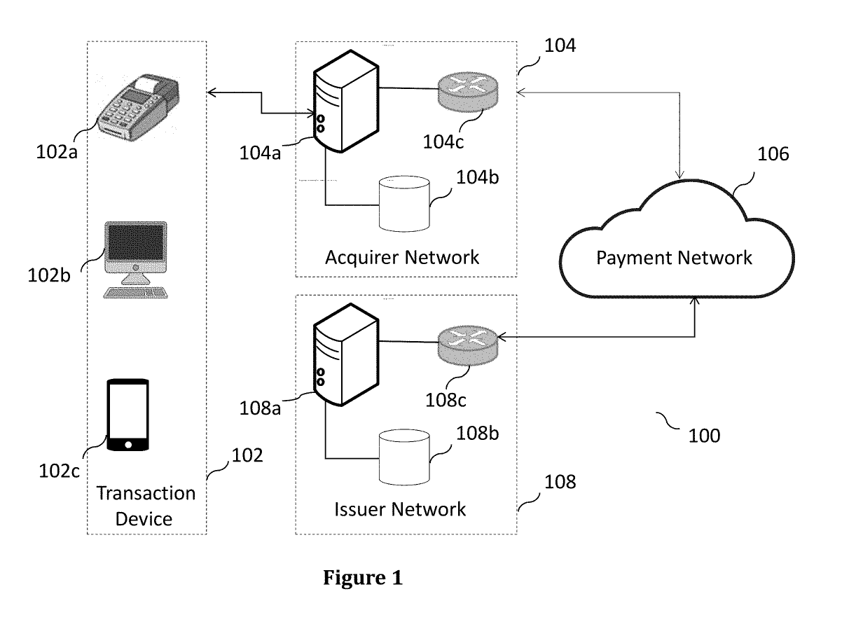

FIG. 1 illustrates a conventional system 100 of a type that is known in the art for the enabling electronic payment transactions based on payment account information or a payment card that is presented by a customer at a transaction device 102. System 100 includes transaction device 102, acquirer network 104, payment network 106 and issuer network 108.

Acquirer network 104 may be communicably coupled with transaction device 102, and comprises server 104a, acquirer network database 104b and interface gateway 104c. Server 104a may be configured to receive and process information relating to electronic payment transactions. In an embodiment, the acquirer network may receive or process transactions received only from merchants having a merchant account with the acquirer—which determination may be made based on information retrieved from acquirer network database 104b. Interface gateway 104c may include a hardware or software network gateway configured to enable acquirer network 104 to communicate with payment network 106.

Payment network 106 may be communicably coupled to both acquirer network 104 and issuer network 108.

Issuer network 108 comprises server 108a, issuer network database 108b and interface gateway 108c. Server 108a may be configured to receive and process information relating to electronic payment transactions. Interface gateway 108c may include a hardware or software network gateway configured to enable issuer network 108 to communicate with card network 106.

It would be understood that in an embodiment, when system 100 is configured to implement the present invention, transaction device 102 may comprise any transaction device having communication capabilities, including without limitation a point-of-sale (POS) terminal device 102a, computing device 102b, or mobile phone or smartphone 102c. In a typical electronic payment transaction, the transaction device 102 is a device owned or maintained by the merchant—at which device the customer presents information that (i) enables identification of the customer's electronic payment account, (ii) optionally enables authentication of the customer's identity, and (iii) enables electronic transfer of payment from the customer's electronic payment account to the merchant's electronic payment account.

A well known difficulty with systems of the type illustrated in FIG. 1 is that the merchant must have and maintain at least one of (i) transaction device 102 and (ii) a pre-existing electronic payment account (for example, a merchant account maintained with an Acquirer). In reality however, due to the lack of widespread financial inclusion, merchants may not have access to a transaction device of the type illustrated in FIG. 1 or to a merchant account set up and maintained with an Acquirer. The present invention seeks to address this difficulty and to enable such merchants to participate in the regular stream of electronic payment based commerce.

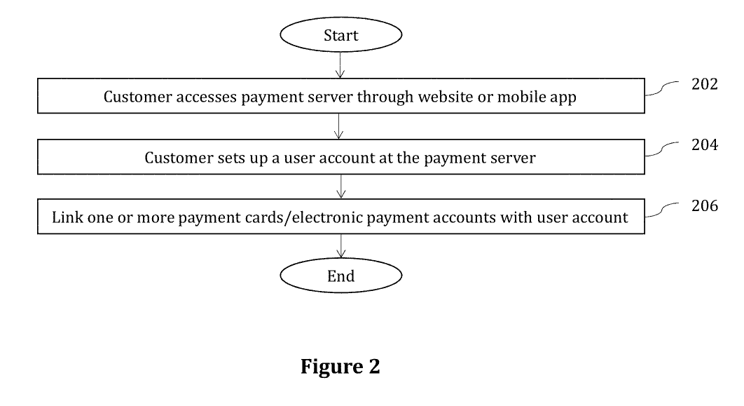

FIGS. 2 to 5 illustrate methods in accordance with the present invention—wherein customers with access to electronic payment infrastructure can make payments electronically to a merchant despite the merchant not having access to devices configured for enabling payment transactions (for example, a POS terminal), or despite the merchant not having access to a payment account capable of receiving electronic payments.

FIG. 2 illustrates a method for setting up of a customer account, for customers who seek to make electronic payments to merchants in accordance with the teachings of the present invention.

At step 202, a customer accesses a payment server through a website or a software application (for example, a software application configured for installation and execution on a mobile communication device). At step 204, the customer may follow a series of instructions and workflows provided through the website or software application, for the setting up a user account at the payment server. The user account may be set up in accordance with any conventionally known one or more methods, and may inter alia require the customer to select a unique customer ID, provide a password, and furnish one or more than one sets of information specified for the purposes of setting up the user account (including for example customer identity information, address information and other relevant demographic information). At step 206 the customer may additionally link one or more payment cards or electronic payment accounts with said user account. The linked one or more payment cards or electronic payment accounts may be used for the purposes of making payments from the user account for the purpose of executing payment transactions sought to be implemented by the customer.

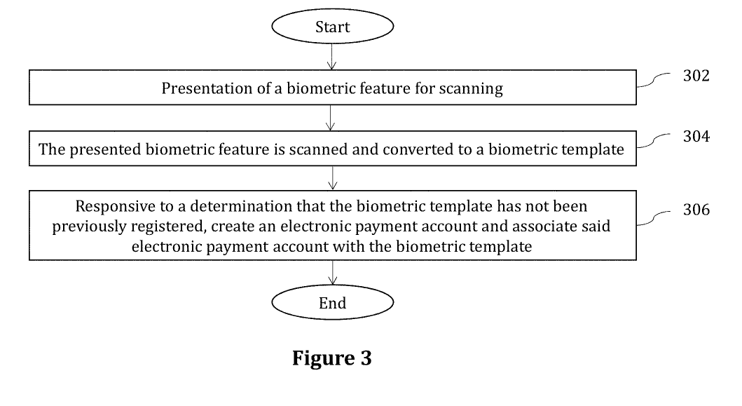

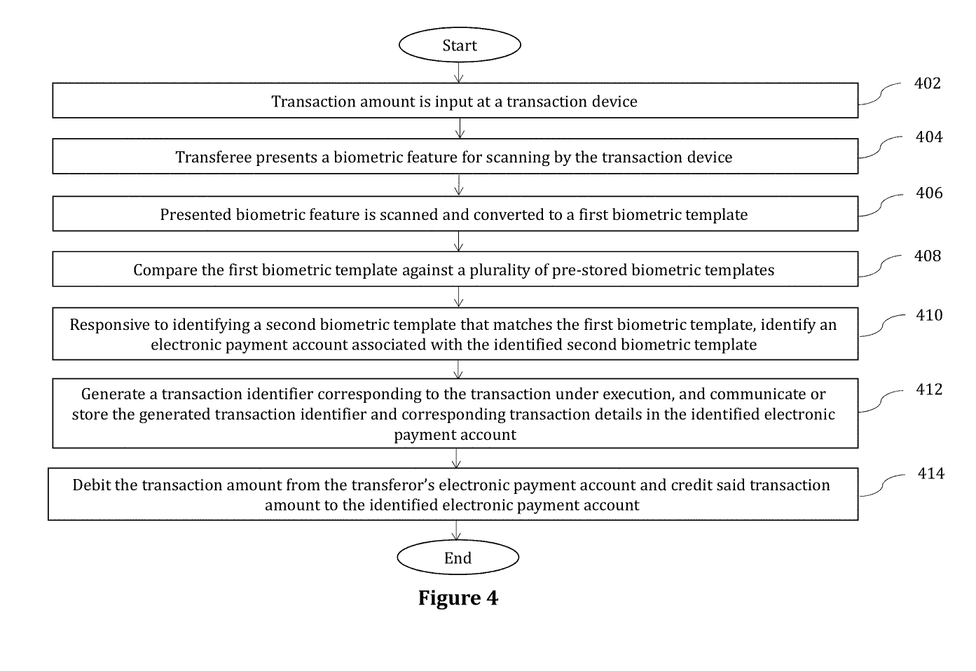

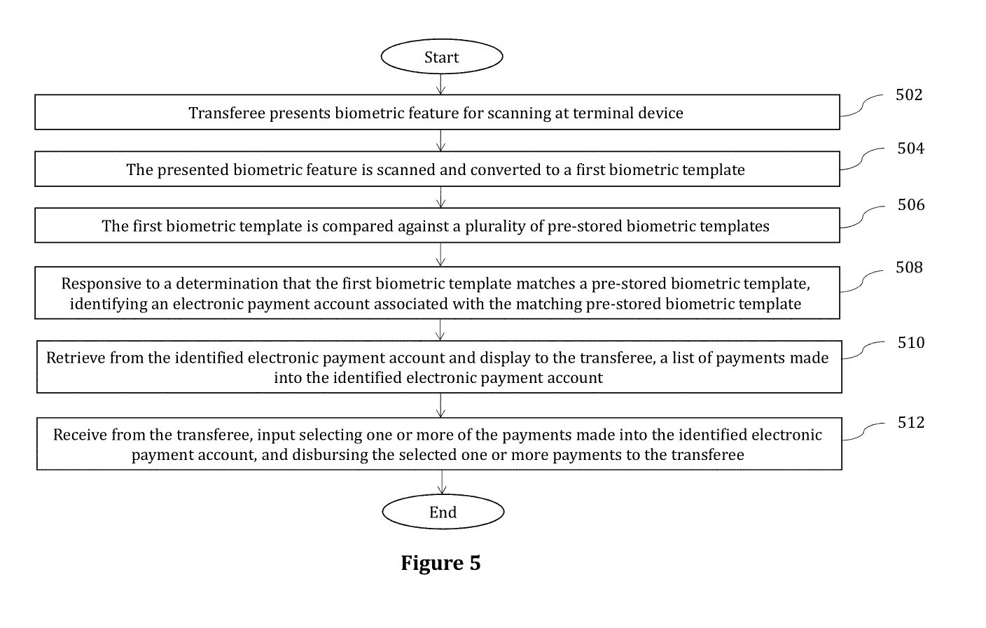

FIG. 3 illustrates an exemplary method for creation of an electronic payment account for a merchant or any intended recipient of a payment transaction, which method may be used for setting up an electronic payment account to enable the methods discussed subsequently in connection with FIGS. 4 and 5 hereinbelow.

The method of FIG. 3 commences at Step 302 with an individual presenting a biometric feature for scanning. For the purposes of the invention, the individual presenting the biometric feature would be the intended transferee of the electronic payment—i.e. the merchant or the intended recipient of the payment. Scanning of the biometric feature may be carried out at a terminal device (for example, a mobile communication device) having biometric feature scanning and/or recognition or matching capabilities, that is in the possession of the transferor of the payment (e.g. the customer).

The biometric feature presented for scanning may comprise any feature of human physiology which is capable of being used for the purposes of biometric identification. Exemplary biometric features that may be presented for scanning may include any of a subject's fingerprint, facial features, palm prints, eye images, iris images, retina images, voice sample, or any other biometric feature or trait that is capable of serving as a unique identifier. The biometric feature may be scanned by any appropriate biometric feature sensor or scanning device incorporated into or communicatively coupled with the transferor/customer's terminal device—and may include any one or more of a camera, image sensor, fingerprint sensor, palmprint sensor, capacitive sensor, pressure sensor, resistive sensor, or eye, iris or retinal scanners, microphone, or any other scanning device capable of capturing the presented biometric feature appropriately for further biometric processing.

At step 304 the presented biometric feature is scanned or otherwise captured, and is converted to a biometric template. The conversion of the captured image or scan of the presented biometric feature to a biometric template may be achieved in accordance with any one of multiple methods that would be apparent to the skilled person, and the selection whereof is dependent on the biometric feature under conversion. In an embodiment, the scanning/capturing of a biometric feature and/or conversion to a biometric template may be achieved through software installed or or accessible through the customer's terminal device—which software may in an embodiment comprise a mobile software application installed on the customer's mobile communication device.

Step 306 comprises determining whether the biometric template generated at step 304 has been previously registered in connection with any pre-existing electronic payment account. This determination is arrived at by (i) comparing the biometric template generated at step 304 against a database of previously stored biometric templates that are respectively associated or linked with pre-existing electronic payment accounts, and (ii) determining whether any of such pre-existing biometric templates match the biometric template under comparison. In the event that a match is found, it would be determined that the individual (i.e. the merchant or intended transferee) who has presented a biometric feature for scanning at step 302 already has an electronic payment account—which electronic payment account is an electronic payment account that is associated or linked with the matching pre-existing biometric template that has been identified at step 306.

Alternatively, responsive to a determination that the biometric template generated at step 304 does not match any previously stored biometric template, it would be determined that said individual (i.e. said merchant or intended transferee) does not have an electronic payment account, in which case (i) a new electronic payment account is generated and stored in a payment account database, and said new electronic payment account is associated or linked with the biometric template generated at step 304. By creating a new payment account and associating it with the biometric template generated at step 304, the invention ensures real time generation of an electronic payment account to enable the proposed electronic payment transaction, as well as instant financial inclusion for the concerned individual. Additionally, the invention ensures that future presentation of the same biometric feature scanned at step 302 would (by following the method steps of FIG. 3) enable identification of the new payment account. The individual with whom such biometric feature is associated, in future only needs to once again present the same biometric feature for scanning—to enable identification of the payment account generated at step 306 for such individual.

FIG. 4 illustrates a method of conducting an electronic payment transaction in accordance with the teachings of the present invention.

Step 402 comprises providing a desired transaction amount as input at a transaction device. For the purposes of this method, the transaction device may include any electronic device through which a transferor is able to access a user account associated with said transferor (for example a user account of the type discussed in connection with the method of FIG. 2). In such embodiments, the website or software application which enables access to the user account may be configured to implement one or more of the method steps illustrated in FIG. 4 and discussed in more detail below. Additionally, by implementing the method steps of FIG. 4 through a user account associated with the transferor, an electronic payment account associated with the transferors' user account may be identified for the purposes of implementing the intended electronic payment transaction. The transaction device may in an embodiment be communicably coupled with a payment network of the type discussed more generally in connection with FIG. 1.

In a specific embodiment, the transaction amount may be input at a website or through a software application that enables transaction instructions to be implemented in respect of an electronic payment account that has been linked or associated with the user account. In an embodiment the transaction device may comprise any network communication enabled terminal device, and preferably may comprise a mobile communication device.

At step 404, the merchant (or intended transferee of the payment transaction) presents a biometric feature for scanning by the transaction device or with a peripheral device having biometric feature capture or scanning capabilities that is communicably coupled with the transaction device. Typically, the merchant or intended transferee would for scanning purposes, present a biometric feature that has been previously scanned, converted to a biometric template and thereafter associated with an electronic payment account associated with the merchant or intended transferee (for example in accordance with the method more generally described in connection with FIG. 3).

At step 406, the biometric feature presented by the intended transferee is scanned and converted to a first biometric template.

At step 408, the first biometric template is compared against a database of pre-stored biometric templates that are respectively associated or linked with pre-existing electronic payment accounts. By virtue of said comparison, step 408 enables ascertaining whether any of such pre-stored biometric templates match the first biometric template.

In the event that a second biometric template from among the plurality of pre-stored biometric templates is found to match the first biometric template, an electronic payment account associated with the identified second biometric template is identified at step 410. It would be understood that the electronic payment account may be identified by referring to database information linking the second biometric template and the identified electronic payment account. It would further be understood that the electronic payment account identified at step 410 is a payment account that has been created by or associated with the person who has presented a biometric feature for scanning at step 404 (i.e. the intended transferee). Alternatively, in the event no pre-existing biometric template is found to match the first biometric template, the method of FIG. 4 may include the further steps of (i) generating a new electronic payment account and storing the new electronic payment account in an electronic payment account database, and (ii) associating or linking said new electronic payment account with the first biometric template.

Step 412 comprises generating a transaction identifier corresponding to or associated with the transaction under execution—and preferably uniquely associated with said transaction under execution. The generated transaction identifier and the details of the corresponding payment transaction may be communicated to, associated with, the intended transferee's electronic payment account that has been identified or generated at step 410. The transaction identifier may comprise any one or more of a numeric or alphanumeric identifier, a 2D or 3D information code (for example, a bar code or QR code) or any other unique transaction identifier.

At step 414 the transaction amount is debited from the transferor's electronic payment account and is credited to the intended transferee's electronic payment account that has been identified or generated at step 410. In one embodiment of the invention, prior to the transaction amount being debited from the transferor's electronic payment account and credited to the intended transferee's electronic payment account, the transferor may be required to provide a specific user input at the transaction device, confirming that the transaction is to be implemented. In an embodiment, along with step of debiting the transaction amount from the transferor's electronic payment account and crediting said amount to the intended transferee's electronic payment account, step 414 may additionally involve marking or categorizing the transaction identifier that has been associated with said transaction as “redeemed” or “completed” to ensure that the same transaction identifier cannot be associated with any subsequent transaction.

By following the method steps of FIG. 4, the invention enables identification or generation of an electronic payment account associated with a merchant or intended transferee and for transfer of electronic funds from a transferor account to a transferee account without requiring the transferee to invest in acquisition or maintenance of a transaction device such as a POS terminal. In an embodiment, the method steps of FIG. 4 can be carried out entirely using a terminal device that is owned or possessed by a transferor or customer—for example, using the transferor's mobile communication device, provided said terminal device has biometric feature scanning capabilities associated therewith.

FIG. 5 illustrates a method for enabling a transferee to access funds that have been electronically transferred into an electronic payment account associated with the transferee in the manner discussed above in connection with FIG. 4.

At step 502 the transferee presents, at a terminal device, a biometric feature for scanning. The terminal device may comprise any device that is configured to access a payment server, including without limitation a client terminal that is communicably coupled with or that is otherwise in network communication with said payment server or with a payment network that is in turn communicably coupled with the payment server. It will be understood that said terminal device may be a device that is different from the transaction device used to implement transfer of electronic payment in accordance with the methods of FIG. 4. In an embodiment, the terminal device may additionally comprise a terminal having cash disbursement facilities—for example an automated teller machine (ATM). The biometric feature that is presented for scanning by the transferee may comprise the biometric feature that has been linked to the transferee's electronic payment account for the purpose of electronic payment account identification.

At step 504, the presented biometric feature is scanned at a biometric sensor or scanner associated with the terminal device, and is converted to a first biometric template. Step 506 comprises comparing the first biometric template against a database of pre-stored biometric templates that are respectively associated or linked with pre-existing electronic payment accounts. Based on said comparison, step 506 ascertains whether any of such pre-stored biometric templates match the first biometric template.

In the event that a second biometric template from among the plurality of pre-stored biometric templates is found to match the first biometric template, an electronic payment account associated or linked with the identified second biometric template is identified at step 508. The electronic payment account may be identified by referring to database information linking the second biometric template and the identified electronic payment account. It would further be understood that the electronic payment account identified at step 508 would be an electronic payment account that has been created by or associated with the transferee who has presented a biometric feature for scanning at step 502. In an alternative embodiment, the transferee may omit the steps of biometric feature scanning and biometric template matching entirely—and may instead input unique account identifier information (for example an account number, account bar code, account QR code or any other such information that enables identification of an electronic payment account associated with the transferee) at the terminal device—for identifying an electronic payment account associated with the transferee.

Step 510 comprises retrieving from the identified electronic payment account, and displaying to the transferee (for example on a display associated or coupled with the terminal device), a list of electronic payments that have been transferred into the identified electronic payment account. In an embodiment of the invention, displaying the list of electronic payments may include displaying one or more unique identifiers associated with each such payment (for example, a transaction identifier of the type generated and stored at step 412 of FIG. 4). Displaying the list of electronic payments may in an embodiment include displaying any one or more of the transaction amount, transaction date and/or time, identity of the transferor, and/or any other information that is descriptive of the concerned transaction and which can be retrieved from the electronic payment account identified at step 508.

Step 512 comprises receiving from the transferee (through the terminal device) input selecting one or more of the payments that have been transferred into the identified electronic payment account. The input selecting one or more payments may be by way of graphic user interface (GUI) based selection, or alternatively by receiving from the transferee one or more inputs (for example an input numeric or alphanumeric code, or a bar code or QR code presented by the transferee for scanning by the terminal device). Responsive to the received input, the terminal device may disburse to the transferee, the selected one or more payments. In an embodiment where the terminal device has cash disbursements facilities, the selected one or more payments may be disbursed to the transferee in cash. It would however be understood that any other equivalent mechanism for disbursement or redemption of payments transferred into the transferee's electronic payment account may be equally implemented, including without limitation, transferring the selected payments to any other electronic payment account or bank account specified by the transferee, or for that matter generating a physical or electronic token that the transferee may present to a designated cashier or at a designated cash disbursement facility (for example a bank) for the purposes of receiving cash payment corresponding to the selected payment amounts.

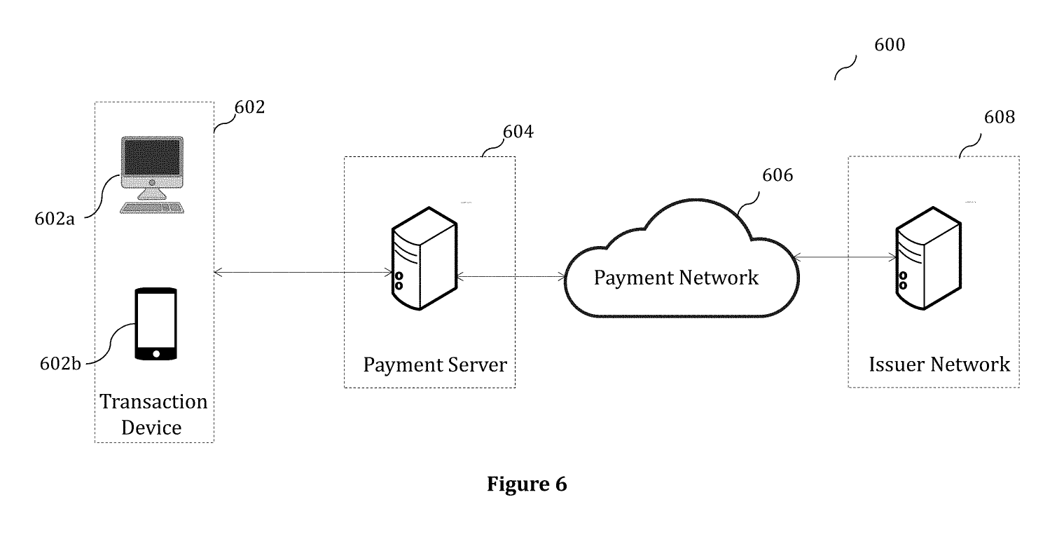

FIG. 6 illustrates an exemplary system 600 configured to implement the methods discussed above in connection with FIGS. 4 and 5. System 600 comprises a transaction device 602—which transaction device 602 may include any electronic device through which a transferor can access a user account associated with said transferor, and which transaction device 602 may be directly or indirectly communicably coupled with a payment network. In FIG. 6, transaction device 602 may include any one of a network connected terminal device 602a or a mobile communication device/smartphone 602b—which have been configured to include capabilities for scanning of one or more biometric features.

Transaction device 602 may be communicably coupled with payment server 604, which payment server is configured for creating and maintaining user accounts in accordance with the teachings of FIG. 2 and/or electronic payment accounts in accordance with the teachings of FIG. 3.

Payment server 604 may additionally be communicably coupled or in network communication with issuer network 608 via payment network 606, such that electronic payments may be effected from a transferor electronic payment account that is created and maintained within issuer network 608 to (i) a transferee electronic payment account that is created and maintained within the same issuer network 608 or any other issuer network that is in network communication with the payment network 606 or (ii) a transferee electronic payment account that has been created and is maintained within payment server 604. It would be understood that payment server 604 may be configured to implement one or more and preferably all of the method steps of FIG. 5 for effecting electronic payments between a transferor electronic payment account (associated with a customer) and a transferee electronic payment account (associated with a merchant/intended transferee). Payment server 604 may additionally be configured to implement one or more of the method steps of FIG. 6 for effecting disbursements of electronic payments that have been received at a transferee electronic payment account that is maintained within payment server 604 (or alternatively within an issuer network connected to payment network 606). It would additionally be understood that in implementing the method steps of FIGS. 5 and 6, payment server 604 may require to rely on one or more ancillary or peripheral systems—for example, in one embodiment, payment server 604 may be communicably coupled with a discrete or separate authentication server that is configured to convert scanned biometric features into biometric templates and to effect the comparison steps involving biometric templates. In another embodiment, payment server 604 may be communicably coupled with one or more terminal devices configured for (i) identifying a transferee and a payment account associated with the transferee, (ii) displaying payments that have been transferred to the transferee's payment account, and/or (iii) disbursing cash in response to redemption instructions from the transferee.

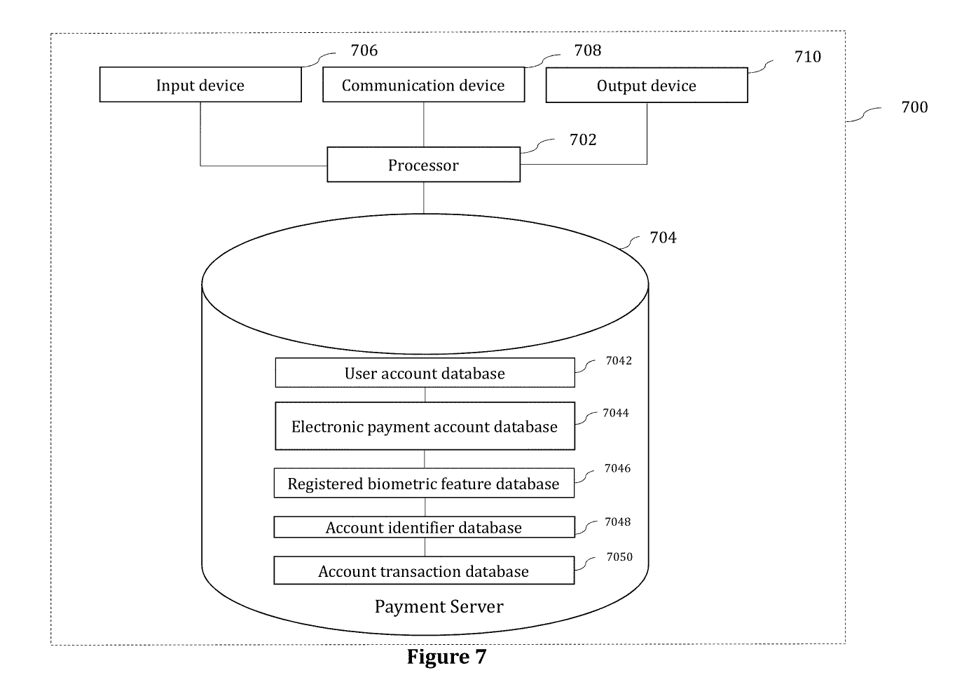

FIG. 7 is a block diagram of an exemplary payment server 700 which may be configured for the purposes of implementing any one or more methods described above. Payment server 700 includes processor 702 which is communicably coupled with storage device 704, input device 706, communication device 708 and output device 710.

Processor 702 may include one or more processors and may be configured to execute processor executable steps, contained in program instructions, so as to control payment server 700 to provide the desired functionality. Input device 706 may include one or more peripheral devices used to input data to a computer or processor (for example, a keyboard or a mouse). Communication device 708 may be configured to enable or facilitate communication with other devices, and may include capabilities for sending and receiving messages over wired networks, wireless networks, and mobile telephone networks, as well capabilities for engaging in data communication over data networks. Output device 710 may in exemplary embodiments comprise a display or a printer.

Storage device 704 any comprise any information storage device, including combinations of magnetic storage devices (e.g., hard disk drives), optical storage devices such as CDs or DVDs, semiconductor based memory devices such as Random Access Memory (RAM) and Read Only Memory (ROM), and/or flash memory. As illustrated in FIG. 7, storage device 704 may host one or more of (i) user account database 7042, which stores data corresponding to one or more user accounts created in accordance with the method of FIG. 2, (ii) Electronic payment account database 7044, which stores data relating to electronic payment accounts that have been linked with each registered user account (in accordance with the teachings of FIG. 2) and/or data relating to electronic payment accounts generated in accordance with the teachings of FIG. 3, (iii) registered biometric feature database 7046, which stores biometric templates that have been associated with or linked to electronic payment accounts stored within electronic payment account database 7044, (iv) account identifier database, which database stores unique account identifiers associated with each electronic payment account (for example, account numbers, account bar codes, account QR codes, or any other information that when input, permits for identification of an associated electronic payment account), and (v) account transaction database 7050—which database stores for each electronic payment account, details of transactions carried out through said electronic payment account—and which transaction details may include without limitation, any one or more of the transaction amount, transaction date and/or time, identity of the transferor, and/or any other information that is associated with the concerned transaction.

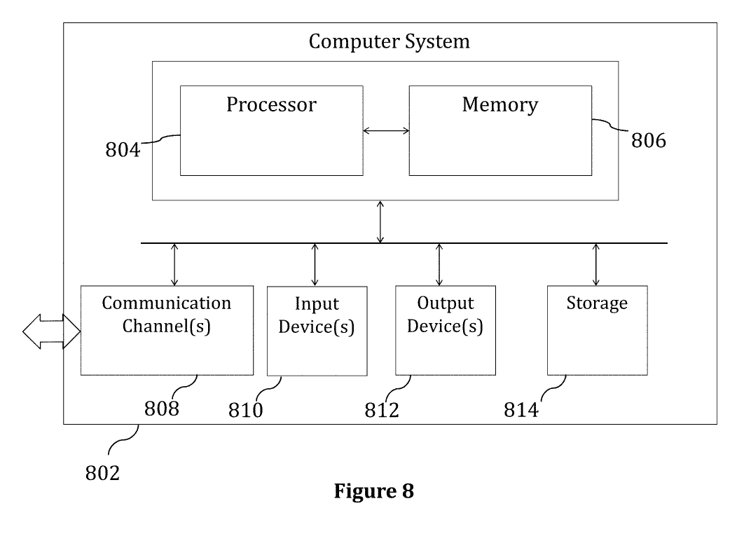

FIG. 8 illustrates an exemplary system 800 for implementing the present invention.

System 800 includes computer system 802 which in turn comprises one or more processors 804 and at least one memory 806. Processor 804 is configured to execute program instructions—and may be a real processor or a virtual processor. It will be understood that computer system 802 does not suggest any limitation as to scope of use or functionality of described embodiments. The computer system 802 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 802 in accordance with the present invention may include one or more servers, desktops, laptops, tablets, smart phones, mobile phones, mobile communication devices, tablets, phablets and personal digital assistants. In an embodiment of the present invention, the memory 806 may store software for implementing various embodiments of the present invention. The computer system 802 may have additional components. For example, the computer system 802 may include one or more communication channels 808, one or more input devices 810, one or more output devices 812, and storage 814. An interconnection mechanism (not shown) such as a bus, controller, or network, interconnects the components of the computer system 802. In various embodiments of the present invention, operating system software (not shown) provides an operating environment for various softwares executing in the computer system 802 using a processor 804, and manages different functionalities of the components of the computer system 802.

The communication channel(s) 808 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 810 may include, but is not limited to, a touch screen, a keyboard, mouse, pen, joystick, trackball, a voice device, a scanning device, or any another device that is capable of providing input to the computer system 802. In an embodiment of the present invention, the input device(s) 810 may be a sound card or similar device that accepts audio input in analog or digital form. The output device(s) 812 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 802.

The storage 814 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 802. In various embodiments of the present invention, the storage 814 may contain program instructions for implementing any of the described embodiments.

In an embodiment of the present invention, the computer system 802 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 802. The method described herein is typically implemented as a computer program product, comprising a set of program instructions that is executed by the computer system 802 or any other similar device. The set of program instructions may be a series of computer readable codes stored on a tangible medium, such as a computer readable storage medium (storage 814), for example, diskette, CD-ROM, ROM, flash drives or hard disk, or transmittable to the computer system 802, via a modem or other interface device, over either a tangible medium, including but not limited to optical or analogue communications channel(s) 808. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages—including convenient and effective ways for improving financial inclusion, by enabling electronic payment transactions to be implemented despite a merchant or intended recipient of payment not having pre-existing electronic payment infrastructure.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

What is claimed is:

1. A method for performing an electronic payment transaction, comprising the steps of:
receiving user input identifying a transaction amount;
acquiring through a first biometric feature sensor, a first set of biometric information defining a biometric feature of a payment transferee;
generating a first biometric template based on the acquired first set of biometric information; and
transferring the transaction amount from a first electronic payment account associated with a payment transferor to a second electronic payment account associated with the payment transferee, wherein the second electronic payment account is identified based on the first biometric template.

2. The method as claimed in claim 1, wherein identifying the second electronic payment account comprises:
comparing the first biometric template against a plurality of pre-stored biometric templates, wherein each pre-stored biometric template is associated with a corresponding pre-existing electronic payment account; and
responding to a determined match between the first biometric template and a second biometric template from among the plurality of pre-stored biometric templates, by identifying as the second electronic payment account, a pre-existing electronic payment account associated with said second biometric template.

3. The method as claimed in claim 2, wherein identifying the second electronic payment account comprises responding to a determination that the first biometric template does not match any of the plurality of pre-stored biometric templates with the further steps of:
generating a new electronic payment account and associating said new electronic payment account with the first biometric template; and
identifying the generated new electronic payment account as the second electronic payment account.

4. The method as claimed in claim 1, wherein the first electronic payment account is identified based on electronic payment account information from a user account associated with the payment transferor.

5. The method as claimed in claim 1, wherein one or more of the user input and the biometric information is acquired through the payment transferor's mobile communication device.

6. The method as claimed in claim 1, wherein the biometric feature comprises any of a fingerprint, facial feature, palm print, eye image, iris image, retina image or voice sample.

7. The method as claimed in claim 1, further comprising the steps of:
generating a transaction identifier uniquely associated with the transaction under execution; and
communicating said transaction identifier to the second electronic payment account.

8. The method as claimed in claim 1, comprising the further steps of:
receiving at a terminal device having cash disbursement capabilities, input identifying the second electronic payment account;
receiving input selecting one or more payments received into the second electronic payment account; and
disbursing cash equivalent to the selected one or more payments from the terminal device.

9. The method as claimed in claim 8, wherein the received input identifying the second electronic payment account comprises a second set of biometric information defining a biometric feature of the payment transferee.

10. The method as claimed in claim 9, wherein the second set of biometric information is acquired through a second biometric feature sensor associated with the terminal device having cash disbursement facilities.

11. A system for performing an electronic payment transaction, the system comprising:
a processor implemented payment server configured for:
receiving user input identifying a transaction amount;
receiving a first set of biometric information defining a biometric feature of a payment transferee, wherein said first set of biometric information is acquired through a first biometric feature sensor;
acquiring a first biometric template, wherein said first biometric template is generated based on the acquired first set of biometric information; and
transferring the transaction amount from a first electronic payment account associated with a payment transferor to a second electronic payment account associated with the payment transferee, wherein the second electronic payment account is identified based on the first biometric template.

12. The system as claimed in claim 11, wherein identifying the second electronic payment account comprises:
comparing the first biometric template against a plurality of pre-stored biometric templates, wherein each pre-stored biometric template is associated with a corresponding pre-existing electronic payment account; and
responding to a determined match between the first biometric template and a second biometric template from among the plurality of pre-stored biometric templates, by identifying as the second electronic payment account, a pre-existing electronic payment account associated with said second biometric template.

13. The system as claimed in claim 12, wherein identifying the second electronic payment account comprises responding to a determination that the first biometric template does not match any of the plurality of pre-stored biometric templates with the further steps of:
generating a new electronic payment account and associating said new electronic payment account with the first biometric template; and
identifying the generated new electronic payment account as the second electronic payment account.

14. The system as claimed in claim 11, wherein the first electronic payment account is identified based on electronic payment account information from a user account associated with the payment transferor.

15. The system as claimed in claim 11, wherein one or more of the user input and the biometric information is acquired at the payment server through a mobile communication device.

16. The system as claimed in claim 11, wherein the biometric feature comprises any of a fingerprint, facial feature, palm print, eye image, iris image, retina image or voice sample.

17. The system as claimed in claim 11, wherein the payment server is configured to:
generate a transaction identifier uniquely associated with the transaction under execution; and
communicate said transaction identifier to the second electronic payment account.

18. The system as claimed in claim 11, wherein the payment server is configured to:
receive through a terminal device having cash disbursement capabilities, input identifying the second electronic payment account;
receive through said terminal device, input selecting one or more payments received into the second electronic payment account; and
implement disbursement of cash equivalent to the selected one or more payments, at the terminal device.

19. The system as claimed in claim 18, wherein the received input identifying the second electronic payment account comprises a second set of biometric information defining a biometric feature of the payment transferee.

20. The system as claimed in claim 19, wherein the second set of biometric information is acquired through a second biometric feature sensor associated with the terminal device having cash disbursement facilities.

21. A computer program product for performing an electronic payment transaction, comprising a non-transitory computer usable medium having computer readable program code embodied therein, the computer readable program code comprising instructions for:
receiving user input identifying a transaction amount;
acquiring through a first biometric feature sensor, a first set of biometric information defining a biometric feature of a payment transferee;
generating a first biometric template based on the acquired first set of biometric information; and
transferring the transaction amount from a first electronic payment account associated with a payment transferor to a second electronic payment account associated with the payment transferee, wherein the second electronic payment account is identified based on the first biometric template.
